(19) United States
(12) Patent Application Publication
(10) Pub. No.: US 2005/0058502 A1
(43) Pub. Date: Mar. 17, 2005

(54) Three-piece loose-leaf binder

(76) Inventor: Yoav Ben-Or, La Salle (CA)

Correspondence Address: AMSTER, ROTHSTEIN & EBENSTEIN;90 PARK AVENUE, NEW YORK, NY, 10016, US

(21) Appl. No.: 10/736,060

(22) Filed: Dec. 15, 2003

Related U.S. Application Data
(60) Provisional application No. 60/503,265, filed on Sep. 15, 2003.

(51) Int. Cl. B42F 3/00

(52) U.S. Cl. 402/70

(57) ABSTRACT

A binder comprising the three elements of a ring assembly, a plastic sheet of substantially uniform thickness, and an outer spine member. The sheet has two score line depressions spaced apart along its length and defining between them an inner spine portion having a front cover and a rear cover on opposite sides. A fastening means is supplied to secure the inner spine portion of the sheet to the ring assembly and the outer spine member.

This application claims priority under 35 U.S.C. §119(e) to Provisional Application No. 60/503,265 filed on Sep. 15, 2003.

### FIELD OF INVENTION

The invention is in the field of loose-leaf binders and more particularly loose-leaf binders using thin sheet plastic for the front and rear covers.

### BACKGROUND OF THE INVENTION

The typical construction of a loose-leaf binder is well-known in the prior art. Commonly, a loose-leaf binder has two covers connected to each other by a spine with a conventional ring assembly affixed on the spine for holding papers. The connection of the ring assembly to the spine is usually by rivets or screws whose heads are exposed on the outside of the spine. Alternatively, rivet-like projections may be integrally molded to extend inwardly from the inside surface of the spine and then to engage the ring assembly. Covers of binders may be separate panels attached to the spine by hinges, or the covers and the spine may be of a contiguous integrally molded plastic, where the hinges are segments of the molded plastic.

Some of the least expensive binders are constructed of a simple thin sheet of uniform thickness forming both the spine portion and the front and rear cover portions with a basic split ring assembly being attached to the thin flat spine portion. More attractive and expensive binders feature a curved spine between the front and rear covers. There have been various attempts in the prior art seeking to achieve this more expensive binder appearance with less expensive materials and methods. For example, U.S. Pat. No. 3,201,145 for “Molded Plastic Loose Leaf Binders” teaches an integrally molded binder with a curved spine, a front cover and a back cover having living hinges and flanges, wherein the rivets for securing the ring assembly to the spine are molded into the spine. Thus, the rivet heads are not visible on the outside surface of the spine.

U.S. Pat. No. 4,295,747 for “Integrally Molded, Looseleaf Books with Ring-Binder-Mounting Posts Molded on Spine” is yet another example that teaches an integrally molded curved spine connected to a front and a back cover by living hinges, wherein a projection is integrally molded on the inner side of the spine for securing a ring assembly. Thus, the rear face of the spine does not have an exposed rivet head or similar attachment projection.

Integrally molded binders are relatively expensive to produce, as they require construction and use of molds for each binder size.

The present invention addresses the need for a binder that resembles the more expensive binders while being inexpensive to produce.

### SUMMARY OF THE INVENTION

This invention is an improved binder and method of constructing same. The new binder is constructed from a flat sheet of plastic having a length and a height, which may be formed by extrusion or other means to form the inner spine portion and the front and rear covers. This extruded sheet of plastic has two score line depressions spaced apart along its length and extending transversely across the height of the sheet, thereby creating the inner spine portion and front and rear covers. The score line depressions serve as living hinge areas between each cover and the inner spine portion. A convex curved or other non-planar shaped outer spine portion of molded plastic is positioned to overlie and fasten with the outside surface of the inner spine portion.

In one embodiment of the new invention, the outer spine member is injection molded to have a convex outer surface with at least two axially spaced ribs integrally molded therewith extending inwardly from the inner surface, flanges integrally molded at each end of the outer spine member extend inwardly like the ribs, and a plurality of rivet like projection means integrally molded therewith, for fastening together the outer spine portion, the inner spine member and the ring assembly.

In this embodiment the inner spine portion defines an elongated rectangular element with two axially spaced apertures along its length.

The ring assembly base defines a generally rectangular element or frame with spaced holes aligned with the apertures of the inner spine portion. The projections of the outer spine member extend through the aligned apertures in the inner spine portion and through the aligned holes in the frame of the ring assembly. The end of each projection is then deformed, preferably by heating, to secure together the outer spine member, inner spine portion and ring assembly.

Other features and advantages of the invention will become apparent from the drawings and description below of the preferred embodiments.

### BRIEF DESCRIPTION OF THE DRAWINGS

FIG. 1 is a perspective view of a binder constructed according to one embodiment of the present invention,

FIG. 2 is a fragmentary cross-sectional view taken on plane 2-2 of FIG. 1,

FIG. 3 is a fragmentary cross-sectional view taken on plane 3-3 of FIG. 2,

FIG. 4 is a fragmentary cross-sectional view similar to FIG. 2 of a second embodiment which shows a binder having an outer spine portion without ribs, and

FIG. 5 is a fragmentary cross-sectional view similar to FIG. 3 taken on plane 5-5 of FIG. 4.

### DETAILED DESCRIPTION OF A PREFERRED EMBODIMENT

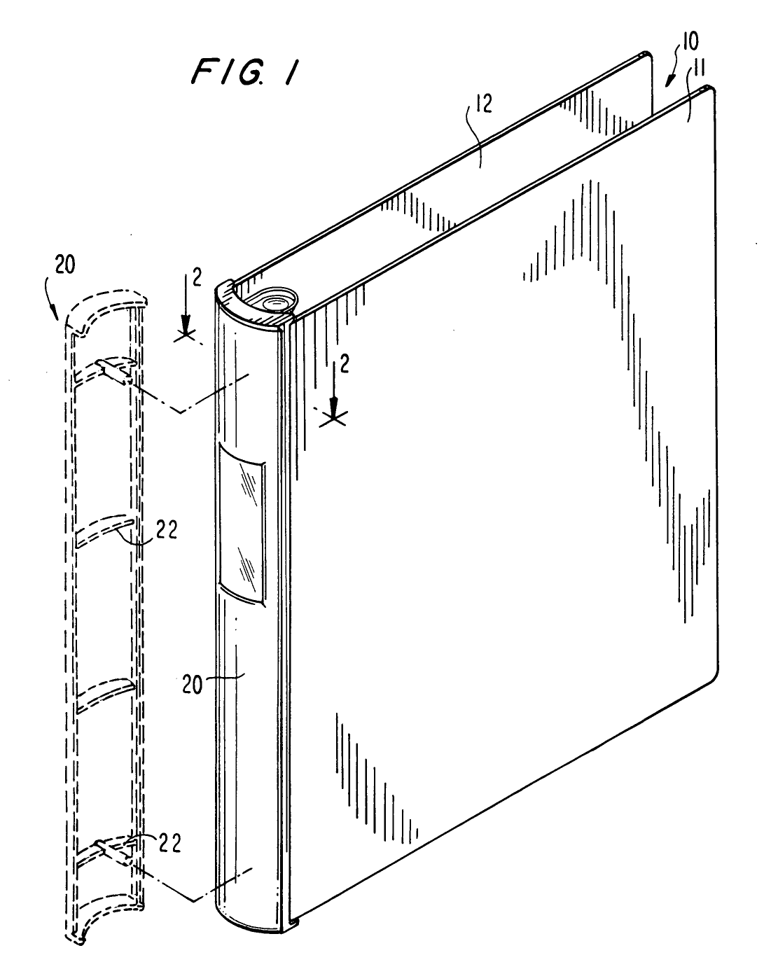

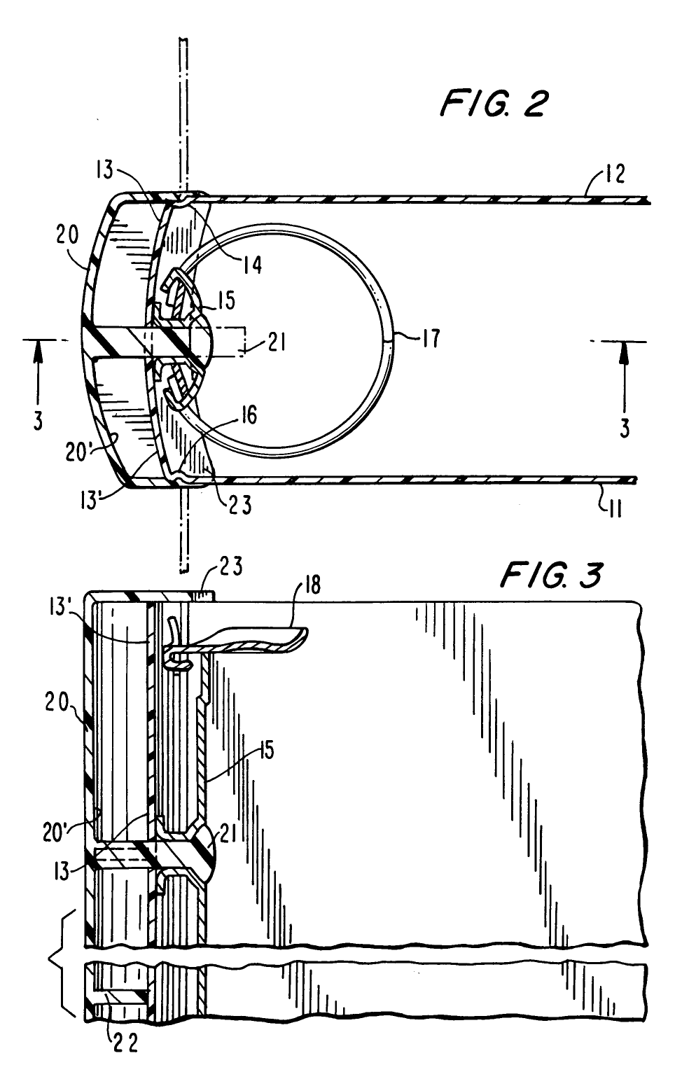

Referring to FIGS. 1-2, the new binder 10 is formed of a continuous extruded flexible plastic sheet of uniform thickness which defines a front cover 11, a rear cover 12 and inner spine portion 13.

The outer surface and inner surface of the sheet may be supplied with various design depressions for identification or aesthetic purposes, as well as textures to vary the friction across each surface. The sheet has two transverse score line depressions 14, 16 typically scored to a depth up to about one-half the sheet thickness. A conventional ring assembly 15 is attached to the inner spine portion 13 by a fastening means extending from the outer spine member 20. The fastening means can be integrally molded into the outer spine member 20, or it may consist of a more traditional rivet or screw device. The conventional ring assembly 15 includes at least two split rings 17, preferably three-split rings, spaced and configured to attach papers with correspondingly spaced holes. The ring assembly 15 typically has two or more holes correspondingly spaced for receiving a fastening means.

FIGS. 1-3 show a first embodiment of the binder having a relatively stiff outer spine member 20 with ribs 22 and two fastening means 21 integrally molded therewith. The outer surface of the outer spine member is convex, and the inner surface of the outer spine portion is concave. Each fastening means 21 is received by a correspondingly spaced aperture of the inner spine portion 13 of the continuous sheet and a correspondingly spaced hole of the ring assembly 15. The end of the fastening means can be dimensioned or adapted so that after it extends through the aperture of the inner spine portion 13 and the hole of the ring assembly 15 it cannot be subsequently withdrawn therefrom. Preferably, the end of the fastening means is deformed to a larger diameter once received by the aperture of the inner spine portion and the hole of the ring assembly, as shown in FIG. 3.

Ribs 22 are integrally molded with the outer spine member 20 and have a cross-sectional area configured to substantially conform to the concave cavity of the outer spine member, such that the ribs 22 provide increased structural stability and support the outer spine from collapsing inwardly and losing its attractive shape.

Flanges 23 can be integrally molded at the ends of the outer spine portion 13 to prevent finger access to the area between the terminal edge or outer surface 13′ of the inner spine portion 13 and remote edge or inner surface 20′ of the outer spine portion 20. The flanges 23 could also be dimensioned to prevent finger access to the usually sharp end edges of the ring assembly. Additionally, the flanges 23 could also be dimensioned to provide added protection to the thumb levers 18 of the ring assembly.

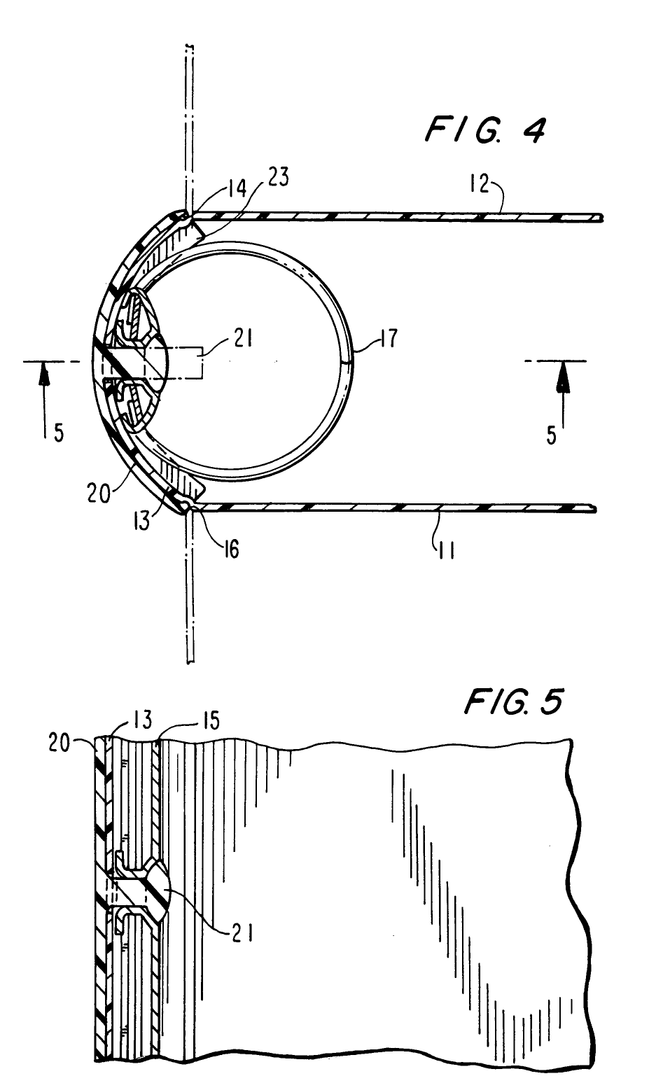

FIGS. 4-5 show a second embodiment where the ribs 22 of the outer spine member 20 shown in FIGS. 1-3 are absent, and the outer surface of the inner spine portion lies flush against the inside surface of the outer spine member. The means for fastening together the ring assembly, inner spine portion and outer spine portion is the same as in the first embodiment.

Alternatively, the means for fastening the ring assembly 15 to the inner spine portion 13 and with the outer spine member 20 is by traditional riveting. In this embodiment the outer spine member 20 has at least two apertures positioned and spaced to align with the apertures of the inner spine portion 13. Assembly of the binder consists of placing a rivet shank through each aperture of the outer spine member. The rivet shank is then received by a correspondingly positioned aperture of the inner spine portion 13 and the corresponding hole of the ring assembly. A clinch rivet, drive post, screw or barb is received by the rivet shank thereby fastening together the ring assembly, inner spine portion and outer spine member. Alternatively, the end of the rivet shank can be peened or otherwise deformed, thereby fastening together the ring assembly, inner spine portion and outer spine member.

One of ordinary skill in the art can envision numerous variations and modifications to the described embodiments. For example, the non-planar outer surface of the outer spine member can be configured to have varying curvatures along its length or width, or can be molded to resemble the shape of a wave or any other combination of geometric shapes. Additional variations, might include making depressions in the sheet for purposes of identification, increased flexibility or aesthetics.

It is to be understood, of course, that the specific forms of the invention herein illustrated are intended to be representative only, as changes may be made which are still within the spirit and scope of the claims set forth below.

1. A binder comprising:
a. a ring assembly comprising an elongated frame having a lengthwise axis with at least two split rings spaced apart axially on said frame, said frame having opposite top and bottom ends;
b. a solid, single layer, plastic sheet of substantially uniform thickness across its entire area, said sheet having a length direction and a height direction and including two score line depressions spaced apart along said length direction and extending transversely across said sheet in said height direction and defining between them an elongated inner spine portion, and a front cover and a rear cover on opposite sides of said inner spine portion, said elongated inner spine portion having an inside surface and an opposite outside surface and opposite top and bottom ends;
c. an elongated outer spine member having an inner surface and a non-planar outer surface;
d. said frame of said ring assembly positioned adjacent said inside surface of said inner spine portion and said outer spine member positioned adjacent said outside surface of said inner spine portion;
e. said outer spine member, said inner spine portion and said frame each having a central longitudinal axis, these three elements being positioned to overlie each other with their central longitudinal axes in general alignment; and
f. means for securing together said outer spine member, said inner spine portion and said frame, as positioned.

2. A binder comprising:
a. a ring assembly comprising an elongated frame having a lengthwise axis with at least two split rings spaced apart axially on said frame and at least two holes extending through said frame transversely of said axis and axially spaced apart from each other, said frame having opposing top and bottom ends;
b. a solid, single layer, plastic of substantially uniform thickness across its entire area, said sheet having a length direction and a height direction and including two score line depressions spaced apart along said length direction and extending transversely across said sheet in said height direction and defining between them an elongated inner spine portion, and a front cover and a rear cover on opposite sides of said inner spine portion, said elongated inner spine portion having an inside surface and an opposite outside surface and opposite tope and bottom ends, said inside surface positioned adjacent to said frame and having at least two axially spaced apertures that correspondingly align with said holes in said frame of said ring assembly;
c. an elongated outer spine member having an inner surface and a non-planar outer surface, said outer spine member positioned adjacent said outside surface of said inner spine portion, including at least two axially spaced apertures that correspondingly align with said apertures in said inner spine portion; and
d. at least two fasteners, each fastener extending through one of said apertures in said outer spine member, through said correspondingly aligned aperture in said inner spine portion, through said correspondingly aligned hole in said frame, and adapted to secure together said outer spine member, said inner spine portion, and said frame, as positioned.

3. A binder comprising:
a. a ring assembly comprising an elongated frame having a lengthwise axis with at least two split rings spaced apart axially on said frame and at least two holes extending through said frame transversely of said axis and axially spaced apart from each other, said frame having opposing ends;
b. a solid, single layer, plastic sheet of substantially uniform thickness across its entire area, said sheet having a length direction and a height direction and including two score line depressions spaced apart along said length direction and extending transversely across said sheet in said height direction and defining between them an elongated inner spine portion, and a front cover and a rear cover on opposite sides of said inner spine portion, said inner spine portion having an inner surface and an opposite side surface and opposite top and bottom ends, said inside surface positioned adjacent to said frame and having at least two axially spaced apertures that correspondingly align with said holes in said frame of said ring assembly; and
c. an elongated outer spine member having an inner surface and a non-planar outer surface and having at least two fasteners extending from said inner surface, said outer spine member positioned adjacent said outside surface of said inner spine portion, each fastener extending from said outer spine member through one of said apertures in said inner spine portion, through said correspondingly aligned hole in said frame, and adapted to secure together said outer spine member, said inner spine portion, and said frame, as positioned.

4. The binder of claim 1 wherein said outer spine member has opposite top and bottom ends and at each of said ends has a flange extending transversely toward said elongated frame and covering each end of said inner spine portion.

5. The binder of claim 1 wherein said outer spine member has opposite top and bottom ends and at each of said ends has a flange dimensioned to extend toward said elongated frame and to conceal each end of said frame.

6. The binder of claim 1 wherein said outer spine member further comprises at least two axially spaced ribs, each rib extending a predetermined distance from said inner surface toward said inner spine portion.

7. The binder of claim 1 wherein said outer spine member has opposite top and bottom ends and at each of said ends has a flange extending transversely toward said elongated frame and covering each end of said inner spine portion, said outer spine member further comprises at least two axially spaced ribs, each rib extending a predetermined distance from said inner surface toward said inner spine portion.

8. The binder of claim 1 wherein the ring assembly has three split rings, each spaced apart axially from the others on said frame.

9. The binder of claim 1 wherein the front cover has an inside surface and an opposite outside surface, and at least said outside surface of said front cover is textured.

10. The binder of claim 1 wherein the rear cover has an inside surface and an opposite outside surface, and at least said outside surface of said rear cover is textured.

11. The binder of claim 3 wherein the outer spine member is formed by injection molding, and said fasteners comprise projections extending from said inner surface of said outer spine portion and integrally molded therewith.

12. The binder of claim 3 wherein each said fasteners has a terminal end that projects through said frame and dimensioned to prevent withdrawal from said frame.

13. The binder of claim 7 wherein the outer spine member is formed by injection molding, and said ribs are integrally molded with said outer spine member.

14. The binder of claim 3 wherein each said fastener extending through said hole in said frame has a terminal end which is deformed to have a diameter greater than the diameter of said hole in said frame to secure together said outer spine member, said inner spine portion and said frame of said ring assembly.

15. The binder of claim 1 wherein said outer surface of said outer spine member is convexly curved outwardly.

16. A binder comprising:
a. a ring assembly comprising an elongated frame having a lengthwise axis with at least two split rings spaced apart axially on said frame, said frame having opposite top and bottom ends;
b. a solid, single layer, plastic sheet of substantially uniform thickness across its entire area except for any depressions in its surface, said sheet having a length direction and a height direction and including two score line depressions spaced apart along said length direction and extending transversely across said sheet in said height direction and defining between them an elongated inner spine portion, and a front cover and a rear cover on opposite sides of said inner spine portion, said elongated inner spine portion having an inside surface and an opposite outside surface and opposite top and bottom ends;
c. an elongated outer spine member having an inner surface and a non-planar outer surface;
d. said frame of said ring assembly positioned adjacent said inside surface of said inner spine portion and said outer spine member positioned adjacent said outside surface of said inner spine portion;
e. said outer spine member, said inner spine portion and said frame each having a central longitudinal axis, these three elements being positioned to overlie each other with their central longitudinal axes in general alignment; and
f. means for securing together said outer spine member, said inner spine portion and said frame, as positioned.

17. A method of making a binder comprising:
a. providing a ring assembly comprising an elongated frame having a lengthwise axis with at least two split rings spaced apart axially on said frame and at least two holes extending through said frame transversely of said axis and axially spaced apart from each other;
b. providing a continuous sheet of solid, single layer, plastic having a length direction and a height direction and having an initial uniform thickness over its entire area;
c. forming two score line depressions on said sheet spaced apart along said length direction and extending transversely across said sheet in said height direction and defining between them an inner spine and a front cover and a rear cover on opposites sides of said inner spine portion, said inner spine portion having an inside surface and an opposite outside surface;
d. forming at least two apertures in the inner spine portion, having centers spaced apart the same distance as said holes in said frame and correspondingly aligned with said holes in said frame;
e. providing an elongated, injection molded outer spine member having an inner surface and a non-planar outer surface and including at least two fastening elements integrally molded therewith, said fastening elements having terminal ends and having centers spaced apart the same distance as said apertures in said inner spine portion and correspondingly aligned with said apertures of said inner spine portion;
f. positioning said ring assembly to overlie said inner surface of said inner spine portion and aligning said apertures and said holes;
g. positioning said outer spine member to overlie said outer surface of said inner spine portion;
h. inserting said fastening elements through said aligned apertures in said inner spine portion and said aligned holes in said frame of said ring assembly with said terminal ends projecting through said frame; and
i. deforming said terminal ends of said fastening elements, thereby binding together said ring assembly, inner spine portion and outer spine member.

18. A method of making a binder comprising:
a. providing a ring assembly comprising an elongated frame having a lengthwise axis and a central longitudinal axis with at least two split rings spaced apart axially on said frame;
b. providing a continuous sheet of solid, single layer, plastic having a length direction and a height direction and having an initial uniform thickness over its entire area;
c. forming two score line depressions on said sheet spaced apart along said length direction and extending transversely across said sheet in said height direction, defining between them an inner spine portion with a central longitudinal axis and a front cover and a rear cover on opposites sides of said inner spine portion, said inner spine portion having an inside surface and an opposite outside surface;
d. providing an elongated, injection molded outer spine member having a central longitudinal axis and an inner surface and a non-planar outer surface;
e. positioning said ring assembly to overlie said inner surface of said inner spine portion;
f. positioning said outer spine member to overlie said outer surface of said inner spine portion;
g. aligning each of said central longitudinal axes of each of said ring assembly, said inner spine portion and said outer spine member;
h. providing means for securing together said ring assembly, inner spine portion and outer spine member; and
i. securing together said ring assembly, inner spine portion and outer spine member, as positioned.
